(19) United States
(12) Patent Application Publication
(10) Pub. No.: US 2025/0185082 A1
(43) Pub. Date: Jun. 5, 2025

(54) METHOD AND SYSTEM FOR OPTIMIZING MULTI-ACCESS PROTOCOL DATA UNIT (MA-PDU) SESSIONS

(71) Applicant: Samsung Electronics Co., Ltd., Suwon-si (KR)

(72) Inventors: Koustav ROY, Bangalore (IN); Lalith KUMAR, Bangalore (IN); Danish Ehsan HASHMI, Bangalore (IN); Jagadeesh GANDIKOTA, Bangalore (IN); Arijit SEN, Bangalore (IN)

(21) Appl. No.: 19/006,835

(22) Filed: Dec. 31, 2024

Related U.S. Application Data
(63) Continuation of application No. PCT/KR2024/019351, filed on Nov. 29, 2024.

(30) Foreign Application Priority Data
Dec. 1, 2023 (IN) 202341081944

(51) Int. Cl. H04W 76/10; H04W 80/10

(52) U.S. Cl. CPC H04W 76/10; H04W 80/10

(57) ABSTRACT

The disclosure relates to a 5G or 6G communication system for supporting a higher data transmission rate. A method performed by a user equipment (UE) for optimizing a multi-access protocol data unit (MA-PDU) session is provided. The method includes determining a corresponding data rate and a corresponding latency requirement associated with a corresponding application running on the UE, comparing the corresponding data rate with a predefined threshold data rate or a calculated threshold data rate and comparing the corresponding latency requirement with a predefined threshold latency or a calculated threshold latency associated with the corresponding application, based on a result of the comparing, determining whether an access type of a network is capable to meet the corresponding current data rate and the corresponding latency requirement, and establishing one of a normal protocol data unit (PDU) session or an MA-PDU session for the at least one group of applications based on a result of the determining of whether the access type of the network is capable to meet the corresponding current data rate and the corresponding latency requirement.

### CROSS-REFERENCE TO RELATED APPLICATION(S)

This application is a continuation application, claiming priority under § 365 (c), of an International application No. PCT/KR2024/019351, filed on Nov. 29, 2024, which is based on and claims the benefit of an Indian Patent Application number 202341081944, filed on Dec. 1, 2023, in the Indian Intellectual Property Office, the disclosure of which is incorporated by reference herein in its entirety.

### BACKGROUND

### 1. Field

The disclosure relates to a field of wireless communication networks. More particularly, the disclosure relates to a method and system for optimizing multi-access protocol data unit (MA-PDU) sessions.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In recent times, majority of User Equipments (UEs) or mobile devices with multiple Subscriber Identify Modules (multi-SIMs) or multiple stacks are known as multi-SIM UEs. The multi-SIM UEs or UEs allow a user to make a call, browse internet, or send short message service (SMS). For example, the multi-SIM UEs may relate to a Dual-SIM Dual-Standby (DSDS) device that has at least two SIMs or at least two stacks.

A corresponding multi-SIM UE of the multi-SIM UEs includes a radio frequency (RF) module to establish a communication between a corresponding multi-SIM UE and a network entity. The RF module comprises a plurality of receiving (Rx) channels and a plurality of transmitting (Tx) channels for receiving downlink (DL) signals and transmitting uplink (UL) signals, respectively. Conventionally, the RF module utilizes only one SIM card/protocol stack at a time for communication with the network entity based on a priority of a service (as decided by the RF Module) requested by a corresponding SIM card of the corresponding multi-SIM UE or the UE. For example, initiating or continuing with a voice call is given higher priority over initiating or continuing a data service. So, if the RF module receives the voice call and data service requests simultaneously from two different SIMs, the RF module provides priority to the voice call over the data service requests. Therefore, in a case if the voice call and the data service are running on the different SIMs, the RF module is occupied with respect to one of the SIMs among the multi-SIMs used for calling instead of the other SIM that is used for data service.

Conventionally, one or more critical applications (hereinafter alternatively referred to as “apps” or “app”) may run in the UEs while connected over a fifth-generation (5G) communication network or a sixth-generation (6G) communication network. The UEs may connect with the 5G or 6G communication network via any default Data Service Subscription (DDS) SIM or a designated DDS SIM (for example, SIM1) for receiving any data service. The RF module of the UEs serves any data requests via the DDS SIM for running the one or more critical apps. However, while serving the one or more critical apps, the RF module may trigger tune-away to other SIMs (for example, SIM2 or non-DDS SIMs) to periodically monitor paging requests on the other SIMs. Thus, one or more critical apps may be suspended/interrupted/halted with poor latency when the RF module monitors paging requests and any responses on the non-DDS SIMs.

Additionally, frequent triggering of the tune-way actions by the RF module may lead to high power consumption and usage of resources at the UEs, which may further lead to overheating or higher battery consumption of the UEs.

Additionally, if any paging request is received from the non-DDS SIM for any higher priority services (such as the voice call), the RF resource gets occupied in order to provide services for the received paging request. Thus, the one or more critical apps get interrupted, paused, or sent to a background during an execution of the higher priority services. For example, a user of the multi-SIM UEs attends a video call via Voice over Internet Protocol (VOIP) on the DDS SIM. The ongoing video call may be interrupted when a voice call is received over the non-DDS SIM during the video call.

Thus, the above-discussed scenarios may lead to a bad user experience as the user wants to experience a hassle-free and uninterrupted service for the prioritized/critical apps. Furthermore, the overheating or higher battery consumption may also lead to user frustration and inconvenience while using the UEs.

As a part of Release 18 Third Generation Partnership Project (3GPP) technical specification, a Multi-Access PDU (MA-PDU) session has been introduced in order to solve the aforementioned issues. The MA-PDU session allows the UE to establish a single PDU session with both access types, i.e., 3GPP and non-3GPP (N3GPP), simultaneously. However, if the MA-PDU session is always connected with the UE may end up with fast power discharging while both access types may not be required based on apps running on the UE. Alternatively, if the MA-PDU session is not established, then the user may experience an interrupted service as discussed hereinabove even if there is a provision to provide multiple access types.

FIG. 1 illustrates a flow chart of a method when a UE always establishes the MA-PDU session, according to the related art. At operation 102, the UE is in an idle state, and thereafter, at operation 104, the user initializes one or more apps on the UE. Further, at operation 106, the UE establishes the MA-PDU session or modifies an existing PDU session to the MA-PDU session irrespective of whether the MA-PDU session is required or not. Therefore, the UE ends up wasting Tx power, and increasing battery consumption of the UE. In addition, a temperature of the UE gets increased even though the MA-PDU session may not be required to provide service for the one or more initialized apps.

FIG. 2 illustrates a flow chart of a method when the UE always establishes a normal PDU session, according to the related art. At operation 202, the UE is in an idle state, and thereby, at operation 204, the user initializes, on the UE, two or more apps that may require high throughput and low latency data services (e.g., 4K video, gaming apps, etc.). Further, at operation 206, the UE establishes a new session as the normal PDU session. Therefore, the user experiences poor performances on the two or more apps as the UE does not utilize MA-PDU sessions even though the 5G or 6G communication network supports the same.

Therefore, it would be advantageous to provide an improved system and method that can overcome each of the above-discussed limitations and challenges of the existing solution for optimizing the MA-PDU sessions.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a field of wireless communication networks. More particularly, the disclosure relates to a method and system for optimizing multi-access protocol data unit (MA-PDU) sessions.

Additional aspects will be set forth in part in the description which follows and, in part, will be apparent from the description, or may be learned by practice of the presented embodiments.

In accordance with an aspect of the disclosure, a method performed by a user equipment (UE) for optimizing a multi-access protocol data unit (MA-PDU) session is provided. The method includes determining a corresponding current data rate and a corresponding latency requirement associated with a corresponding application of at least one group of applications running on the UE, comparing the corresponding current data rate with a predefined threshold data rate or a calculated threshold data rate associated with the corresponding application and comparing the corresponding latency requirement with a predefined threshold latency or a calculated threshold latency associated with the corresponding application, based on a result of the comparing, determining whether an access type of a network is capable to meet the corresponding current data rate and the corresponding latency requirement, and establishing one of a normal protocol data unit (PDU) session or an MA-PDU session for the at least one group of applications based on a result of the determining of whether the access type of the network is capable to meet the corresponding current data rate and the corresponding latency requirement.

In accordance with another aspect of the disclosure, a user equipment (UE) for optimizing a multi-access protocol data unit (MA-PDU) session is provided. The UE includes memory, and a processor communicatively coupled with the memory, wherein the processor is configured to determine a corresponding current data rate and a corresponding latency requirement associated with a corresponding application of at least one group of applications running on the UE, compare the corresponding current data rate with a predefined threshold data rate associated with the corresponding Application and compare the corresponding latency requirement with a predefined threshold latency associated with the corresponding application, based on a result of the comparing, determine whether an access type of a network is capable to meet the corresponding current data rate and the corresponding latency requirement, and establish one of a normal protocol data unit (PDU) session or an MA-PDU session for the at least one group of applications based on a result of the determining of whether the access type of the network is capable to meet the corresponding current data rate and the corresponding latency requirement.

In accordance with another aspect of the disclosure, one or more non-transitory computer-readable storage media storing one or more computer programs including computer-executable instructions that, when executed by one or more processors of a user equipment (UE) individually or collectively, cause the UE to perform operations are provided. The operations include determining a corresponding current data rate and a corresponding latency requirement associated with a corresponding application of at least one group of applications running on the UE, comparing the corresponding current data rate with a predefined threshold data rate or a calculated threshold data rate associated with the corresponding application and comparing the corresponding latency requirement with a predefined threshold latency or a calculated threshold latency associated with the corresponding application, based on a result of the comparing, determining whether an access type of a network is capable to meet the corresponding current data rate and the corresponding latency requirement, and establishing one of a normal protocol data unit (PDU) session or a multi-access protocol data unit (MA-PDU) session for the at least one group of applications based on a result of the determining of whether the access type of the network is capable to meet the corresponding current data rate and the corresponding latency requirement.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a flow chart of a method when a UE always establishes an MA-PDU session, according to the related art;

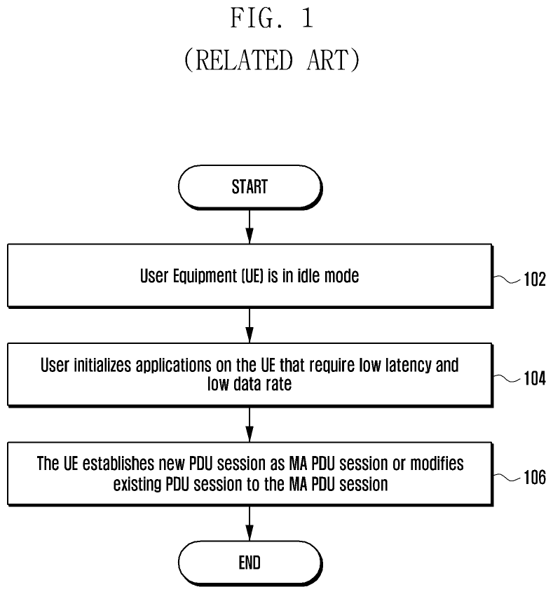

FIG. 2 illustrates a flow chart of a method when a UE always establishes a normal PDU session, according to the related art;

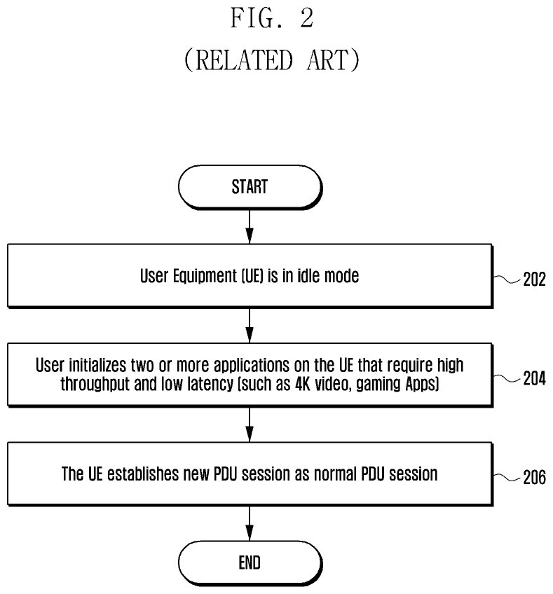

FIG. 3 illustrates a schematic block diagram of a system for optimizing an MA-PDU session, according to an embodiment of the disclosure;

FIG. 4 illustrates a flow chart of a method for optimizing an MA-PDU session, according to an embodiment of the disclosure;

FIG. 5A illustrates a flow chart for establishing or converting to a normal PDU session as disclosed in operation 410 of FIG. 4 based on a remaining energy level of a UE, according to an embodiment of the disclosure;

FIG. 5B illustrates a line diagram of sequential operations for establishing or converting to a normal PDU session based on a remaining energy level of a UE, according to an embodiment of the disclosure;

FIG. 6A illustrates a flow chart for restricting a reception of paging requests from an MA-PDU session based on a remaining energy level of a UE, according to an embodiment of the disclosure;

FIG. 6B illustrates a line diagram of sequential operations for restricting reception of paging requests based on a remaining energy level of a UE, according to an embodiment of the disclosure;

FIG. 7A illustrates a flow chart for establishing or converting to a normal PDU session as disclosed in operation 410 of FIG. 4 based on a temperature of a UE, according to an embodiment of the disclosure;

FIG. 7B illustrates a line diagram of sequential operations for establishing or converting to a normal PDU session based on a temperature of a UE, according to an embodiment of the disclosure;

FIG. 8A illustrates a flow chart for restricting a reception of paging requests from an MA-PDU session based on a temperature of a UE, according to an embodiment of the disclosure;

FIG. 8B illustrates a line diagram of sequential operations for restricting reception of paging requests based on a temperature of a UE, according to an embodiment of the disclosure; and

FIG. 9 illustrates a flow chart for establishing an MA-PDU session by determining a split ratio, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

The term “some” or “one or more” as used herein is defined as “one”, “more than one”, or “all.” Accordingly, the terms “more than one,” “one or more” or “all” would all fall under the definition of “some” or “one or more”. The term “an embodiment”, “another embodiment”, “some embodiments”, or “in one or more embodiments” may refer to one embodiment or several embodiments, or all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents. The phrase “exemplary” may refer to an example.

More specifically, any terms used herein such as but not limited to “includes,” “comprises,” “has,” “consists,” “have” and grammatical variants thereof do not specify an exact limitation or restriction and certainly do not exclude the possible addition of one or more features or elements, unless otherwise stated, and must not be taken to exclude the possible removal of one or more of the listed features and elements unless otherwise stated with the limiting language “mush comprise” or “needs to include.”

Whether or not a certain feature or element was limited to being used only once, either way, it may still be referred to as “one or more features”, “one or more elements”, “at least one feature”, or “at least one element.” Furthermore, the use of the terms “one or more” or “at least one” feature or element does not preclude there being none of that feature or element unless otherwise specified by limiting language such as “there needs to be one or more” or “one or more element is required.”

Unless otherwise defined, all terms, and especially any technical and/or scientific terms, used herein may be taken to have the same meaning as commonly understood by one having ordinary skill in the art.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Embodiments of the disclosure will now be described below in detail with reference to the accompanying drawings.

The terms “network” and “network interface” may be used as synonyms throughout the description without deviating from the scope of the disclosure.

The term “3GPP access type” used in the description corresponds to any type of network access technology for connecting through a 3GPP network, for example, 5g network connection, 6g network connection, etc.

The term “non-3GPP access type” used in the description corresponds to any type of network access technology that is not based on the 3GPP standards. Examples of non-3GPP access types include Wireless Fidelity (Wi-Fi), Worldwide Interoperability for Microwave Access (WiMax), satellite, and wired connections like Ethernet, etc.

The term “MA-PDU session” used in the description relates to allowing user equipment to establish a single PDU session with both access types, i.e., the 3GPP access type and the non-3GPP (N3GPP) access type, simultaneously.

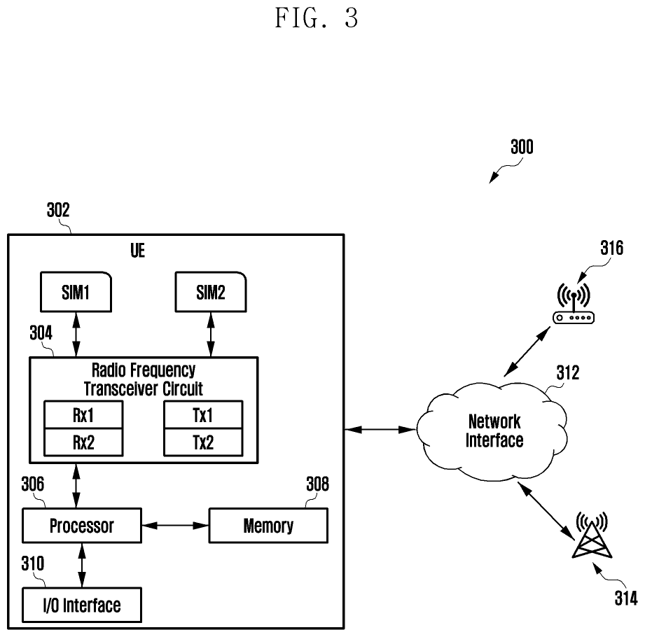

FIG. 3 illustrates a schematic block diagram of a system for optimizing an MA-PDU session, according to an embodiment of the disclosure.

Referring to FIG. 3, according to an embodiment, a system 300 includes a user equipment (UE) 302, which includes a plurality of subscriber identity modules (SIM1, SIM2), a radio frequency (RF) transceiver circuit 304, a processor 306, memory 308, and an input/output (I/O) interface 310. The RF transceiver circuit 304 includes a plurality of transmitters and a plurality of receivers. For example, the plurality of transmitters relates to (Rx1, Rx2), and the plurality of receivers relates to (Tx1, Tx2). The UE 302 is configured to communicate with a network interface 312. As an embodiment, the UE 302 may correspond to, but is not limited to, a smartphone, a mobile device, other mobile devices, a portable communication device, a laptop, a tablet, etc. having the plurality of SIMs for communicating via the network interface 312.

According to an embodiment, each of the SIMs (for example, SIM1, SIM2) is an integrated circuit that securely stores an international mobile subscriber identity (IMSI) number and a key related to the corresponding SIMs. The IMSI number and a key related to the IMSI uniquely identify the user using the corresponding SIMs. Each of the SIMS, also known as a stack, and may include a limited memory for storing contact details or messages. According to one or more embodiments, the SIM may relate to an embedded SIM or eSIM. The eSIM is a programmable SIM card embedded directly into the device. The eSIM is configured with advanced security protocols and is more secure than a normal SIM. Also, the eSIM cannot be removed or unmounted from the device. The eSIM may be activated instantly using scanning a quick response (QR) code corresponding to the service operator. According to some embodiments, the UE 302 may include N numbers of SIM, such as SIM1, SIM2 . . . , SIM N, where N can be any positive integer number greater than or equal to two. In a non-limiting example, a dual-SIM UE may include two SIMs for establishing communication with the network interface 312. Further, a triple-SIM UE includes three SIMs for establishing communication with the network interface 312.

According to an embodiment, the RF transceiver circuit 304 is communicatively coupled with the plurality of SIMs for transmitting and receiving a plurality of communication signals to and from the network interface 312. According to another embodiment, the RF transceiver circuit 304 may include N numbers of receivers (Rx1, Rx2, . . . , RxN) and M number of transmitters (Tx1, Tx2, . . . , TxM), where N can be any positive integer number greater than or equal to two, and M can be any positive integer number greater than or equal to two. Each of the plurality of receivers includes a receiving channel for receiving downlink (DL) signals from the network interface 312 to the UE 302. Each of the plurality of transmitters includes a transmission channel for transmitting uplink (UL) signals from the UE 302 to the network interface 312.

According to an embodiment, the processor 306 may be operatively coupled to the RF transceiver circuit 304, the memory 308, and the I/O interface 310. The processor 306 may be configured for processing, executing, or performing a plurality of operations disclosed throughout the disclosure. According to an embodiment, the processor 306 may include at least one data processor for executing processes in the UE 302. The processor 306 may include specialized processing units such as integrated system (bus) controllers, memory management control units, floating point units, graphics processing units, digital signal processing units, etc. In an embodiment, the processor 306 may include a central processing unit (CPU), a graphics processing unit (GPU), or both. The processor 306 may be one or more general processors, digital signal processors, application-specific integrated circuits, field-programmable gate arrays, servers, networks, digital circuits, analogue circuits, combinations thereof, or other now-known or later developed devices for analyzing and processing data. The processor 306 may execute a software program, such as code generated manually (i.e., programmed) to perform the desired operation.

According to an embodiment, the memory 308 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 308 is communicatively coupled with the processor 306 to store bitstreams or processing instructions for completing the process. Further, the memory 308 may include an operating system for performing one or more tasks of the system 300, as performed by a generic operating system in the communications domain. The memory 308 may also store data blocks generated by the UE 302 for future processing.

According to an embodiment, the I/O interface 310 refers to hardware or software components that enable data communication between the UE 302 and any other UEs, devices, or systems. The I/O interface 310 serves as a communication medium for exchanging information, commands, or data with the other devices or systems. The I/O interface 310 may be a part of the processor 306 or maybe a separate component. The I/O interface 310 may be created in software or maybe a physical connection in hardware. The I/O interface 310 may be configured to connect with an external network, external media, the display, or any other components, or combinations thereof. The external network may be a physical connection, such as a wired Ethernet connection, or may be established wirelessly.

According to an embodiment, the network interface 312 refers to any entity that performs one or more functionalities of a network connection between the UE 302 and a plurality of base stations. Further, the network connection may be established between the UE 302 and the plurality of base stations via a communication port or interface or using a bus (not shown). The communication port may be configured to connect with a network, external media, memory, or any other components in a system, or combinations thereof. The network connection may be a physical connection, such as a wired Ethernet connection, or may be established wirelessly. Likewise, the additional connections with other components of the system 300 may be physical or may be established wirelessly. The network may alternatively be directly connected to the bus.

According to an embodiment, the UE 302 may establish communication with a 3GPP access type 314 (for example, base station) or a non-3GPP (N3GPP) access type 316 (for example, Wi-Fi or WiMax) via the network interface 312. The MA-PDU session allows the UE 302 to establish a single PDU session with both access types, i.e., the 3GPP access type 314 and the non-3GPP access type 316, simultaneously. In a non-limiting example, the UE 302 may use the Tx1 for communicating with the 3GPP access type 314 and the Tx2 for communicating with the non-3GPP access type 316. In another non-limiting example, in the MA-PDU session, the user may receive a voice call over the 3GPP access type 314 via the Tx1, and simultaneously access data for email communication via the non-3GPP access type 316 via the Tx2. Thus, the user can use both access types simultaneously via the MA-PDU session.

According to an embodiment, the processor 306 of the UE 302 is configured to perform a set of operations for optimizing the MA-PDU session. The processor 306 is configured to determine a corresponding data rate and a corresponding latency requirement of a corresponding application of at least one group of applications running on the UE. The group of applications relates to one or more applications having similar data rate and latency requirement. For example, social media applications, such as messaging apps, tweeting messages, etc., require a low data rate. Alternatively, an online video game, a 4K video, etc. requires a high data rate.

Further, the processor 306 of the UE 302 is configured to compare the corresponding current data rate with a predefined or a calculated threshold data rate associated with the corresponding applications. Furthermore, the processor 306 of the UE 302 is configured to compare the corresponding latency with a predefined or a calculated threshold latency associated with the corresponding applications. Therefore, the threshold data rate or the threshold latency is associated with the corresponding applications only. Based on a result of the comparison, the processor 306 is configured to determine whether an access type of a network is capable to meet the determined corresponding current data rate and latency requirement. Thus, the processor 306 is configured to determine whether the access type available with the UE 302 is capable to meet the current data rate and latency requirement of the corresponding applications. Based on a result of the determination, the processor 306 is configured to establish one of the normal PDU session of 3GPP access type 314 or the MA-PDU session of non-3GPP access type 316 for the at least one group of applications to meet the requirements of the data rate and the latency requirement.

In a non-limiting example, if the processor 306 is configured to determine that the UE 302 has the access type as the normal PDU session via the network interface 312. The normal PDU session is established via either the 3GPP access type 314 or the non-3GPP access type 316 based on a signal strength or other factors such as possible data rate, latency etc. or Tx power requirement of the 3GPP access type 314 or the non-3GPP access type 316. Further, the processor 306 is configured to determine that the normal PDU session is capable of meeting the requirement of the current data rate and latency requirement. Then, the processor 306 is configured to continue with the normal PDU session. However, if the normal PDU session is unable to meet the requirement of the current data rate and latency requirement, then the processor 306 is configured to establish the MA-PDU session via both the 3GPP access type 314 and the non-3GPP access type 316 to meet the requirement of the current data rate and latency requirement. Therefore, the user is able to access all applications via multiple access types. Therefore, the disclosure improves user experience and enhances user satisfaction.

Alternatively, the UE 302 may be connected via the MA-PDU session. Further, the processor 306 is configured to determine that the normal PDU session is sufficient to meet the requirement of the current data rate and latency requirement. Thus, based on the determination, the processor 306 is configured to convert the MA-PDU session to the normal PDU session. Therefore, the disclosure saves battery resources, and computation resources without hampering the user experience.

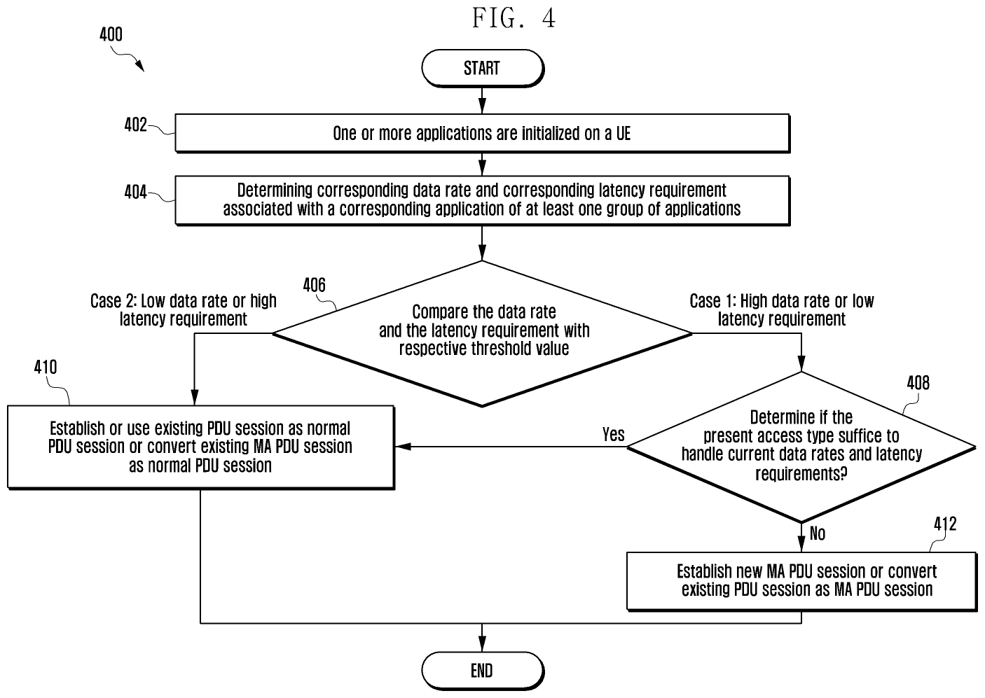

FIG. 4 illustrates a flow chart of a method for optimizing the MA-PDU session, according to an embodiment of the disclosure.

Referring to FIG. 4, method 400 includes a series of operations 402 through 410 for optimizing the MA-PDU session. The details of the method 400 have been explained below in forthcoming paragraphs. The order in which the method operations are described below is not intended to be construed as a limitation, and any number of the described method operations can be combined in any appropriate order to execute the method or an alternative method. Additionally, individual operations may be deleted from the method without departing from the spirit and scope of the disclosure. The method 400 begins from a start block and starts execution of operation 402, as shown in FIG. 4.

At operation 402, the method 400 comprises initializing one or more applications on the UE 302. The one or more applications on the UE 302 may be associated with the applications initialized by the user. Furthermore, the one or more applications may be associated with the applications scheduled by the user for initializing at a certain time. Upon initializing, the one or more applications are running on a background session or in a foreground session of the UE. In a non-limiting example, the user initializes a 4K video from a video streaming app, opens the social media app for updating status, etc. The flow of the method 400 now proceeds to operation 404.

At operation 404, the method 400 comprises determining corresponding current data rate and corresponding latency requirement associated with the corresponding applications of at least one group of applications running on the UE 302. The application of the at least one group of applications corresponds to one or more applications running in the foreground session or the background session of the UE 302. Further, the group of applications comprises one or more applications running on the UE 302 having similar data rate and latency requirement. The processor 306 is configured to determine the corresponding data rate and corresponding latency requirement for the corresponding applications running on the UE 302. Further, the processor 306 is configured to determine the group of applications within which the corresponding application falls into. For example, the processor 306 is configured to determine whether the corresponding application falls into the group of applications that require low data rate and high latency. The flow of the method 400 now proceeds to operation 406.

At operation 406, the method 400 comprises comparing the determined corresponding current data rate with a predefined or a calculated threshold data rate associated with the corresponding applications. The method 400 further comprises comparing the determined corresponding latency with a predefined or a calculated threshold latency associated with the corresponding applications. Particularly, the processor 306 is configured to compare the corresponding current data rate with the predefined or the calculated threshold data rate. The predefined threshold data rate corresponds to a fixed data rate value for determining high or low data rate requirements for corresponding applications. The calculated threshold data rate corresponds to a variable data rate value dynamically calculated based on a heuristic algorithm and a type of the corresponding applications or can also be configured or preconfigured based on UE or operator or Network requirement. The heuristic algorithms may correspond to any one of, but are not limited to, a genetic algorithm, a simulated annealing, a hill climbing algorithm, an A-star algorithm, etc. The variable data rate is determined based on the heuristic algorithms and the type of the corresponding applications.

Further, the processor 306 is configured to compare the determined corresponding latency with the predefined or the calculated threshold latency. The predefined threshold latency corresponds to a fixed latency value for determining high or low latency requirement for corresponding applications. Furthermore, the calculated threshold latency corresponds to a variable latency value dynamically calculated based on the heuristic algorithm and the type of corresponding applications or can also be configured or preconfigured based on UE or operator or Network requirement.

According to an embodiment, if the determined corresponding current data rate is greater than the predefined or the calculated threshold value, then the corresponding applications have a high data rate requirement. Furthermore, if the determined corresponding current data rate is less than the predefined or the calculated threshold value, then the corresponding applications have a low data rate requirement. Similarly, if the determined corresponding latency is greater than the predefined or the calculated latency, then the corresponding applications have a high latency requirement. Further, if the determined corresponding latency is less than the predefined or the calculated latency, then the corresponding applications have a low latency requirement. Thus, based on the comparison, the processor 306 is configured to determine whether the corresponding applications have the high data rate requirement, the low data rate requirement, the high latency requirement, or the low latency requirement.

Upon comparing, the flow of method 400 proceeds to operation 408, i.e., case 1, if the corresponding applications have the high data rate or low latency requirement. Alternatively, the flow of method 400 proceeds to operation 410, i.e., case 2, if the corresponding applications have the low data rate or high latency requirement.

At operation 408, the method 400 comprises determining whether the access type of a network is capable to meet the determined corresponding current data rate and latency requirement. The processor 306 is configured to determine whether the access type of the network currently available with the UE 302 is capable of meeting the current data rate or latency requirement. The access type corresponds to the 3GPP access type 314 and the non-3GPP access type 316. Based on the result of the determination, the method comprises establishing one of the normal PDU session or the MA-PDU session for the at least one group of applications. If the access type of the network available with the UE 302 is sufficient to meet the requirements of the current data rate or latency requirement, the flow of the method 400 proceeds to operation 410. Alternatively, if the access type of the network available with the UE 302 is insufficient to meet the requirements of the current data rate or latency requirement, the flow of the method 400 proceeds to operation 412.

At operation 410, the method 400 comprises establishing or using the normal PDU session for the at least one group of applications upon determining that the access type of the network is capable to meet the determined corresponding current data rate and the latency requirement. The normal PDU session is established via either the 3GPP access type 314 or the non-3GPP access type 316 based on a signal strength of the 3GPP access type 314 or the non-3GPP access type 316. In a non-limiting example, if the signal strength of the 3GPP access type 314 fluctuates frequently and the non-3GPP access type 316 provides better signal strength, the UE 302 may establish the normal PDU session via the non-3GPP access type 316. Further, the method 400 comprises converting the MA-PDU session to the normal PDU session.

At operation 412, the method comprising establishing the MA-PDU session for the at least one group of applications upon determining that the access type of the network is incapable of handling the determined corresponding current data rate and the latency requirement. The processor 306 may be configured to either establish a new MA-PDU session or convert the existing normal PDU session to the MA-PDU session. For establishing the new MA-PDU session or converting to the MA-PDU session by including request type or any other IE as “MA PDU Request” during PDU session establishment or modification procedure, the UE 302 transmits an MA-PDU request message to the network interface 312 via an uplink (UL) non-access stratum (NAS) transport message. In response to the transmitted MA-PDU request message, the UE 302 receives an Access Traffic Steering, Switching, and Splitting (ATSSS) rule from the network interface 312. Upon receiving the ATSSS rule, the method 400 comprises establishing the MA-PDU session with the network via each of the 3GPP access type 314 and the non-3GPP access type 316 simultaneously. The ATSSS rule defines one or more rules by which the UE 302 routes uplink data over both access types, i.e., the 3GPP access type 314 and the non-3GPP access type 316.

Further, upon establishing either the normal PDU session or the MA-PDU session, the method 400 comprises detecting a change in the determined corresponding current data rate and the latency requirement of the corresponding applications. Furthermore, the method 400 comprises determining whether the established (i.e., the normal PDU session or the MA-PDU session) access type of the network is capable of meeting the detected change in the current data rate and the latency requirement. If the established access type is capable of meeting the detected change in the current data rate and the latency requirement, then the method 400 comprises continuing with same access type. Alternatively, if the established access type is incapable of meeting the detected change in the current data rate and the latency requirement, the method 400 comprises converting the established normal PDU session to the MA-PDU session or vice-versa. In a non-limiting example, if the established access type relates to the normal PDU session, and the detected change of data rate relates to high data rate. Then, the method 400 comprises converting the normal PDU session to the MA-PDU session. In another non-limiting example, if the established access type relates to the MA-PDU session, and the detected change of data rate relates to low data rate, then the MA-PDU session is not required for the UE 302. Thus, the method 400 comprises converting the MA-PDU session to the normal PDU session.

It is to be noted that operations 402 through 412 and other operations disclosed herein are performed by the processor 306 of the UE 302.

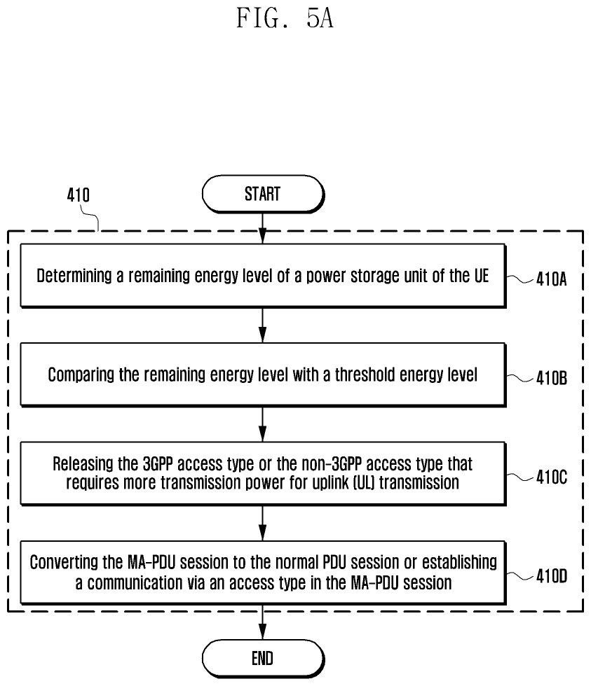

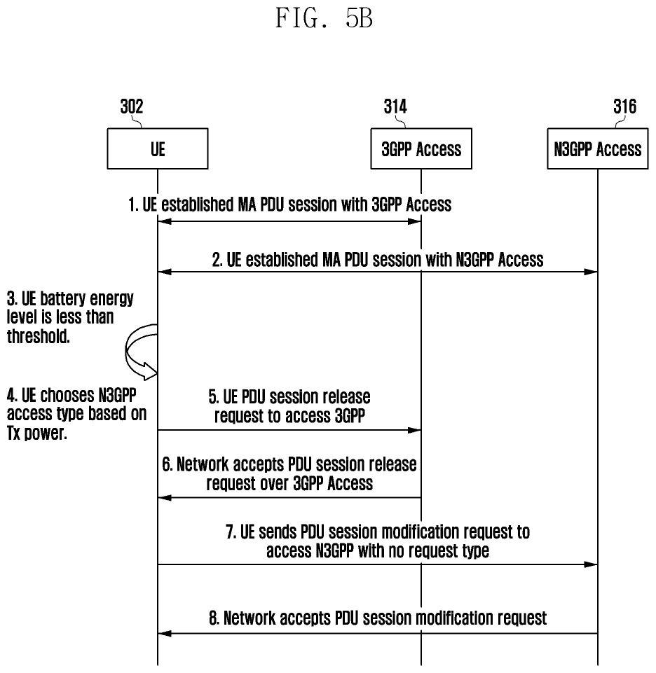

FIG. 5A illustrates a flow chart for establishing or converting to the normal PDU session as disclosed in operation 410 of FIG. 4 based on a remaining energy level of the UE, according to an embodiment of the disclosure.

In the MA-PDU session, the UE 302 receives data from both the 3GPP access type 314 and the non-3GPP access type 316 via the network interface 312. In one aspect, the MA-PDU session brings more data throughput and lesser latency by always considering the best access type between the 3GPP access type 314 and the non-3GPP access type 316 or both access types simultaneously. However, the MA-PDU session consumes more Tx power (as both Tx1 and Tx2 are used), computation power, data aggregation overhead, and choosing access type responsibility for each data packet. So, the MA-PDU session results in more battery consumption compared to the normal PDU session. Thus, as shown in FIG. 5A, the operation 410 determines the energy or battery level of the UE 302 to determine between the normal PDU session and the MA-PDU session.

Referring to FIG. 5A, at operation 410A, the method comprises determining a remaining energy level of a power storage unit of the UE. The power storage unit may relate to the battery of the UE 302. Thus, the processor 306 is configured to determine the remaining energy level of the battery in the UE 302. The flow of the method now proceeds to operation 410B.

At operation 410B, the method comprises comparing the remaining energy level with a threshold energy level. Particularly, the processor 306 is configured to compare the remaining energy level with the threshold energy level to determine whether the UE 302 has sufficient energy or not. In a non-limiting example, the threshold energy level may correspond to 20%. Thus, the processor 306 is configured to compare whether the remaining energy or battery level of the UE 302 is greater than or less than 20%. The flow of the method now proceeds to operation 410C.

At operation 410C, the method comprises releasing any of the 3GPP access type 314 or the non-3GPP access type 316, if a result of the comparison indicates that the remaining energy level is lower than the threshold energy level. Particularly, the processor 306 is configured to release the 3GPP access type 314 or the non-3GPP access type 316 which requires more transmission power for UL transmission in comparison to other access type among the 3GPP and the non-3GPP access types. The flow of the method now proceeds to operation 410D.

At operation 410D, the method comprises converting the MA-PDU session to the normal PDU session upon releasing either the 3GPP access type 314 or the non-3GPP access type 316. Alternatively, the method may comprise establishing a communication via an access type in the MA-PDU session for communicating with the network interface 312 via the other access type. Particularly, the processor 306 is configured to either convert the MA-PDU session to the normal PDU session or establish the communication via the access type in the MA-PDU session for communicating with the other access type. As the other access type requires less transmission power, therefore, the processor 306 is configured to establish the access type to communicate with the network interface 312 via the other access type.

Further, when the remaining energy level is greater than the threshold energy level, the method includes converting from the normal PDU session to the MA-PDU session or establishing via each of the 3GPP access type 314 and the non-3GPP access type 316 simultaneously in the MA-PDU session. Particularly, the processor 306 is configured to convert the normal PDU session to the MA-PDU session or access MA-PDU sessions once the remaining energy level is greater than the threshold energy level. Thus, the processor 306 is configured to meet the determined corresponding current data rate and latency requirement upon accessing the MA-PDU session.

In addition, instead of determining the transmission power required by the access type, the processor 306 may be configured to determine at least one of, but not limited to, a plurality of parameters, such as an average data rate (higher data rate relates to a better access type), an average packet loss (lower packet loss relates to a better access type), data rate requirement of the corresponding applications, Local Area Data Network (LADN) service availability (if the LADN service is available, then it is better to choose the LADN service providing access type e.g. the 3GPP access type 314), an operator preferred access type, or a pre-configured access type (if no information available based on the pre-configuration, the UE 302 may choose the access type). Based on the determination of at least one of the plurality of parameters, the processor 306 may be configured to determine the other access type.

FIG. 5B illustrates a line diagram of sequential operations for establishing or converting to the normal PDU session based on the remaining energy level of the UE, according to an embodiment of the disclosure.

The sequential operations are shown in FIG. 5B as being between the UE 302, the 3GPP access type 314, and the non-3GPP access type 316. In this scenario, it is taken into consideration that the Tx power of the 3GPP access type 314 is greater than the Tx power of the non-3GPP access type 316.

Referring to FIG. 5B, at operations 1 and 2 of FIG. 5B, the UE 302 establishes the MA-PDU session with the 3GPP access type 314 and the non-3GPP access type 316, respectively. Further, at operation 3 of FIG. 5B, the processor 306 is configured to determine that the remaining energy level of the power storage unit is less than the threshold energy level. Furthermore, at operation 4 of FIG. 5B, the processor 306 is configured to determine that the non-3GPP access type 316 requires less Tx power. Thus, at operation 5 of FIG. 5B, the processor 306 is configured to transmit a release request to the network interface 312 to release the 3GPP access type 314. At operation 6 of FIG. 5B, the network interface 312 accepts the release request from the UE 302 to release the 3GPP access type 314. At operation 7 of FIG. 5B, the UE 302 transmits a modification request to the network interface 312 with a no request type message to convert the MA-PDU session to the normal PDU session for accessing non-3GPP access type 316. At operation 8 of FIG. 5B, the network interface 312 accepts the no request message and modifies the MA-PDU session to the normal PDU session for accessing the non-3GPP access type 316.

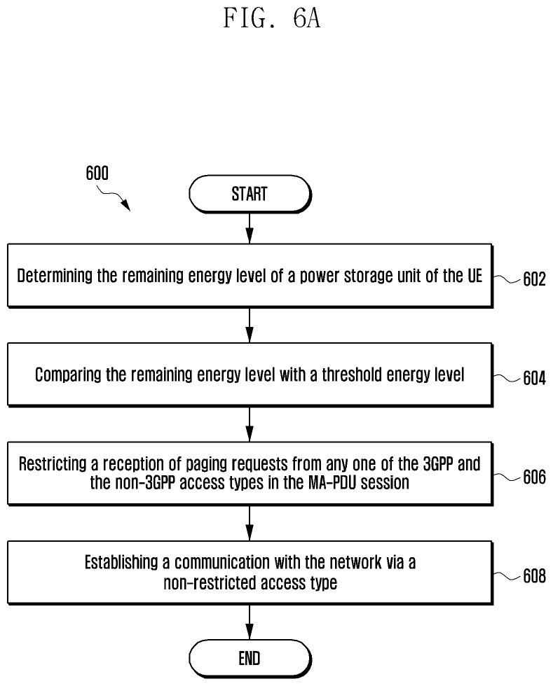

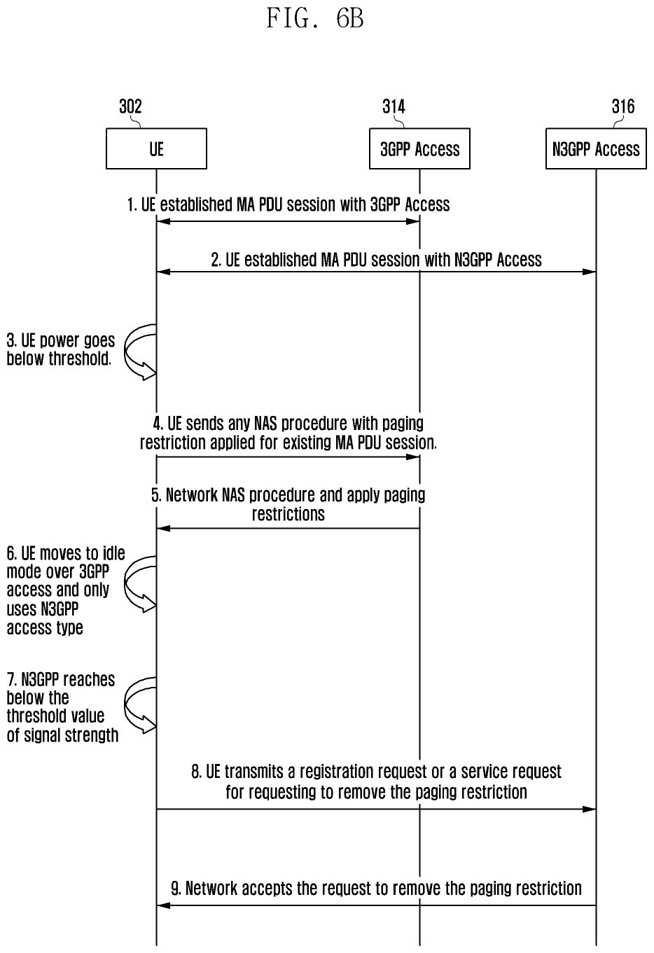

FIG. 6A illustrates a flow chart of a method for restricting a reception of paging requests from the MA-PDU session based on the remaining energy level of the UE, according to an embodiment of the disclosure.

Referring to FIG. 6A, at operation 602, method 600 comprises determining the remaining energy level of a power storage unit of the UE. The processor 306 is configured to determine the remaining energy level of the battery in the UE 302. The flow of the method 600 now proceeds to operation 604.

At operation 604, the method 600 comprises comparing the remaining energy level with the threshold energy level. Particularly, the processor 306 is configured to compare the remaining energy level with the threshold energy level to determine whether the UE 302 has sufficient energy or not. The flow of the method 600 now proceeds to operation 606.

At operation 606, if a result of the comparison indicates that the remaining energy level is lower than the threshold energy level, the method 600 comprises restricting the reception of paging requests from any one of the 3GPP access type 314 and the non-3GPP access type 316 in the MA-PDU session. Particularly, the processor 306 is configured to restrict the reception of paging requests in the MA-PDU session via non-access stratum (NAS) or access stratum (AS) signaling messages to save energy of the UE 302. The paging request relates to a message sent by either the 3GPP access type 314 or the non-3GPP access type 316 to the UE 302 for requesting access to the Tx or Rx channel. Further, the NAS and the AS signaling messages are used to transfer control information between the UE 302 and the 3GPP access type 314/the non-3GPP access type 316. Thus, the processor 306 is configured to transfer the controlling message via the NAS or AS signaling message to any one of the 3GPP access type 314 or the non-3GPP access type 316 for restricting access in the MA-PDU session. The flow of the method 600 now proceeds to operation 608.

At operation 608, upon restricting the reception of the paging requests from the any one of the 3GPP and the non-3GPP access types, the method 600 comprises establishing a communication with the network via a non-restricted access type. Particularly, the method 600 comprises establishing communication via the non-restricted access type among the 3GPP access type 314 and the non-3GPP access type 316 in the MA-PDU session. In a non-limiting example, if the Tx power of the 3GPP access type 314 is more than the non-3GPP access type 316, the processor 306 is configured to restrict the 3GPP access type 314 in the Tx of the RF transceiver circuit 304. Further, the processor 306 is configured to restrict paging requests once the signal strength of the other access type is greater than a threshold value of signal strength to continue providing required services. In another non-limiting example, if the signal strength of the non-restricted access type reaches below the threshold value of signal strength, then the processor 306 is configured to remove the paging restriction to avoid any service discontinuity. Thus, the present scenario avoids modifying existing PDU sessions repeatedly.

FIG. 6B illustrates a line diagram of sequential operations for restricting reception of paging requests based on the remaining energy level of the UE, according to an embodiment of the disclosure.

The sequential operations are shown in FIG. 6B in between the UE 302, the 3GPP access type 314, and the non-3GPP access type 316.

Referring to FIG. 6B, at operations 1 and 2 of FIG. 6B, the UE 302 establishes the MA-PDU session with the 3GPP access type 314 and the non-3GPP access type 316, respectively. Further, at operation 3 of FIG. 6B, the processor 306 is configured to determine whether the remaining energy level of the power storage unit is less than the threshold energy level. Furthermore, at operation 4 of FIG. 6B, the UE 302 transmits the NAS signaling message to the 3GPP access type 314 via the network interface 312 to restrict paging requests in the MA-PDU session. In operation 5 of FIG. 6B, network interface 312 accepts requests of the NAS signaling message to apply paging restriction on the 3GPP access type 314. In operation 6 of FIG. 6B, the UE 302 moves in idle mode for the 3GPP access type 314 and only uses the non-3GPP access type 316 for data transmission. In another embodiment, in operation 7 of FIG. 6B, if the non-3GPP access type 316 reaches below the threshold value of signal strength, then in operation 8 of FIG. 6B, the UE 302 requests the network interface 312 to remove the paging restriction by transmitting a Registration Request or a Service Request. Further, in operation 9 of FIG. 6B, the network interface 312 accepts the requests from the UE 302 and removes the paging restrictions to avoid any service discontinuity.

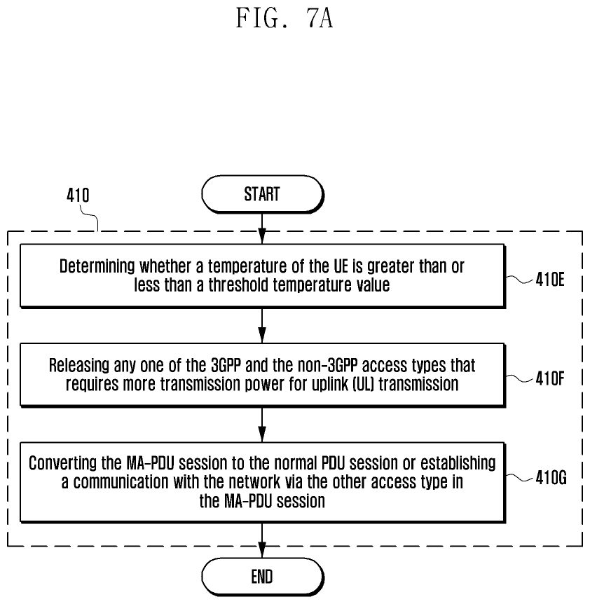

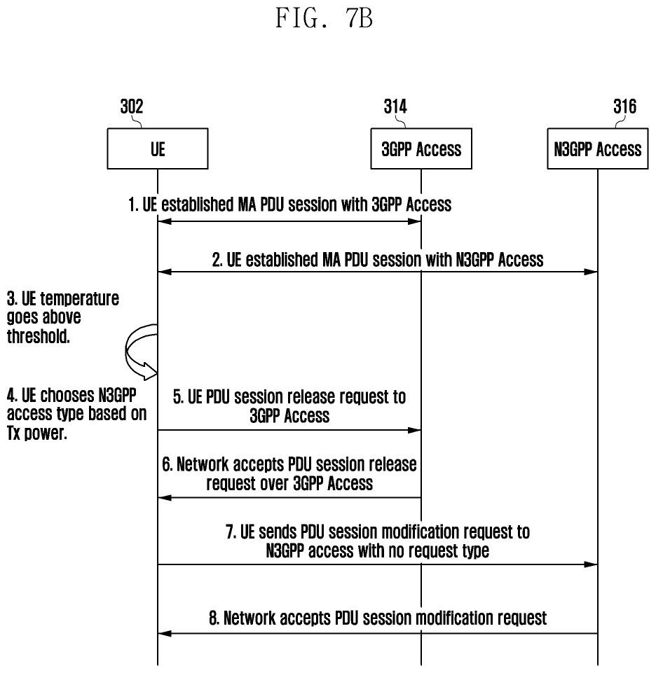

FIG. 7A illustrates a flow chart for establishing or converting to the normal PDU session as disclosed in operation 410 of FIG. 4 based on a temperature of the UE, according to an embodiment of the disclosure.

In the MA-PDU session, the UE 302 receives data from both the 3GPP access type 314 and the non-3GPP access type 316 via the network interface 312. So, the MA-PDU session results in a higher temperature rise compared to the normal PDU session. Thus, it is required for thermal mitigation to avoid overheating by handling the MA-PDU session efficiently or removing the MA-PDU session. Thus, as shown in FIG. 7A, the operation 410 determines a temperature of the UE 302 to determine between the normal PDU session and the MA-PDU session.

Referring to FIG. 7A, at operation 410E, the method comprises determining whether the temperature of the UE 302 is greater than or less than a threshold temperature value. Particularly, the processor 306 is configured to determine whether the temperature of the UE 302 is greater than or less than the threshold temperature value. The flow of the method now proceeds to operation 410F.

At operation 410F, when the determined temperature is greater than the threshold temperature value, the method comprises releasing any one of the 3GPP and the non-3GPP access types. Releasing any one of the 3GPP access type 314 or the non-3GPP access type 316 depends on the transmission power required for UL transmission. Thus, if the 3GPP access type 314 requires more transmission power than the non-3GPP access type 316, then the processor 306 is configured to release the 3GPP access type 314. Alternatively, if the non-3GPP access type 316 requires more transmission power than the 3GPP access type 314, then processor 306 is configured to release the non-3GPP access type 316. In a non-limiting example, the threshold temperature level may correspond to 50° C. Thus, the processor 306 is configured to compare whether the temperature of the UE 302 is greater than 50° C. If the temperature of the UE 302 is greater than 50° C., the processor 306 is configured to release any one of the 3GPP access type 314 and the non-3GPP access type 316 that requires more transmission power than the other access type. The flow of the method now proceeds to operation 410G.

At operation 410G, upon the release of any one of the 3GPP access type 314 or the non-3GPP access type 316, the method comprises converting the MA-PDU session to the normal PDU session. The UE 302 communicates with the network interface 312 in the normal PDU session via the other access type that requires less transmission power than a released access type. Particularly, the processor 306 is configured to release the 3GPP access type 314 or the non-3GPP access type 316 which requires more transmission power for UL transmission in comparison to other access. Thus, the processor 306 is configured to convert the MA-PDU session to the normal PDU session for communicating with the network via the other access type. Alternatively, the processor 306 is configured to establish communication with the network via the other access type in the MA-PDU session.

In addition, instead of determining the transmission power required by the access type, the processor 306 may be configured to determine at least one of, but not limited to, the plurality of parameters, such as the average data rate (higher data rate relates to a better access type), the average packet loss (lower packet loss relates to a better access type), data rate requirement of the corresponding applications, Local Area Data Network (LADN) service availability (if the LADN service is available, then it is better to choose the LADN service providing access type e.g. the 3GPP access type 314), the operator preferred access type, or the pre-configured access type (if no information available based on the pre-configuration, the UE 302 may choose the access type). Based on the determination of at least one of the plurality of parameters, the processor 306 may be configured to determine the other access type once the temperature of the UE 302 is greater than the threshold temperature value.

FIG. 7B illustrates a line diagram of sequential operations for establishing or converting to the normal PDU session based on the temperature of the UE, according to an embodiment of the disclosure.

The sequential operations are shown in FIG. 7B in between the UE 302, the 3GPP access type 314, and the non-3GPP access type 316.

Referring to FIG. 7B, at operations 1 and 2 of FIG. 7B, the UE 302 establishes the MA-PDU session with the 3GPP access type 314 and the non-3GPP access type 316, respectively. Further, at operation 3 of FIG. 7B, the processor 306 is configured to determine whether the temperature of the UE 302 is greater than the threshold temperature level. Furthermore, at operation 4 of FIG. 7B, the UE 302 determines that the non-3GPP access type 316 requires more transmission power than the 3GPP access type 314. Thus, at operation 5 of FIG. 7B, the processor 306 is configured to transmit the release request to the network interface 312 to release the 3GPP access type 314. At operation 6 of FIG. 7B, the network interface 312 accepts the release request from the UE 302 to release the 3GPP access type 314. At operation 7 of FIG. 7B, the UE 302 transmits the PDU Session modification request to the network interface 312 with the no request type message to convert the MA-PDU session to the normal PDU session for accessing non-3GPP access type 316. At operation 8 of FIG. 7B, the network interface 312 accepts the no request message and modifies the MA-PDU session to the normal PDU session for accessing the non-3GPP access type 316.

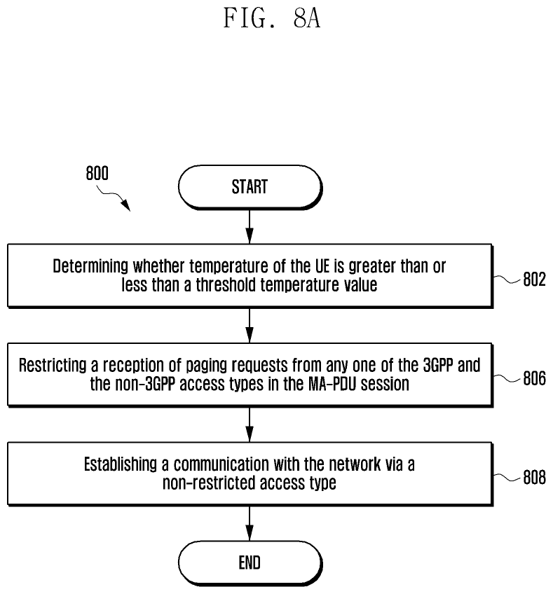

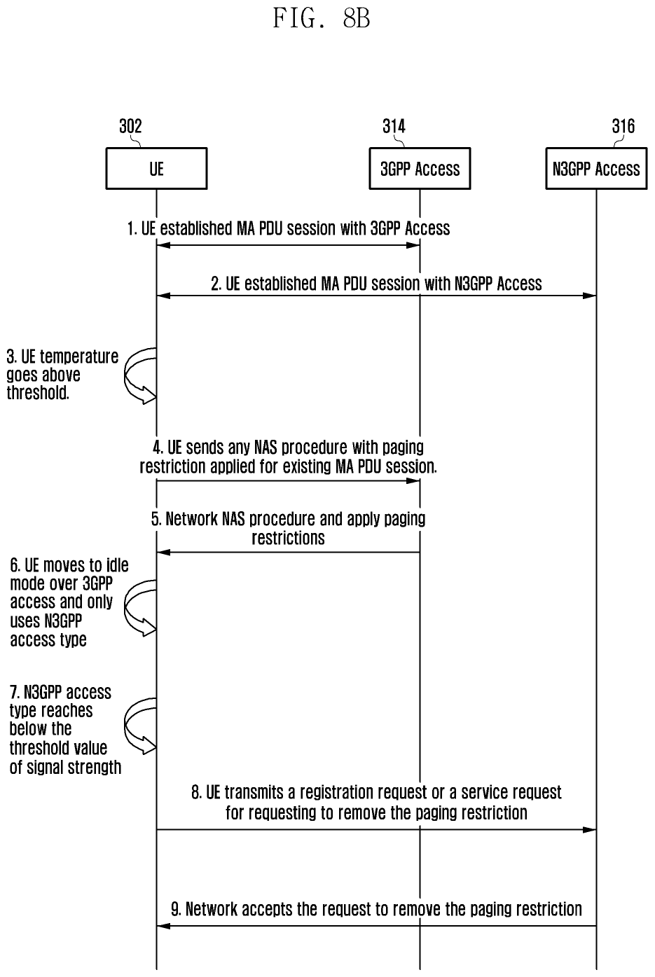

FIG. 8A illustrates a flow chart of a method for restricting a reception of paging requests from the MA-PDU session based on the temperature of the UE, according to an embodiment of the disclosure.

Referring to FIG. 8A, at operation 802, method 800 comprises determining the temperature of the UE 302. The processor 306 is configured to determine the temperature of the UE 302. Further, the processor 306 is configured to determine whether the temperature of the UE 302 is greater than or less than the threshold temperature value. The flow of the method 800 now proceeds to operation 806.

At operation 806, when the determined temperature is greater than the threshold temperature value, the method 800 comprises restricting a reception of paging requests from any one of the 3GPP and the non-3GPP access types in the MA-PDU session via an NAS or AS signaling message. Particularly, the processor 306 is configured to restrict the reception of paging requests in the MA-PDU session via the NAS or AS signaling messages to reduce the temperature of the UE 302. Thus, the processor 306 is configured to transfer the controlling message via the NAS or AS signaling message to the any one of the 3GPP access type 314 and the non-3GPP access type 316 for restricting access in the MA-PDU session. The flow of the method 800 now proceeds to operation 808.

At operation 808, upon restricting the reception of the paging requests from the any one of the 3GPP and the non-3GPP access types, the method 800 comprises establishing a communication with the network via a non-restricted access type. Particularly, the method 800 comprises establishing communication via the non-restricted access type among the 3GPP access type 314 and the non-3GPP access type 316 in the MA-PDU session. In a non-limiting example, if the Tx power of the 3GPP access type 314 is more than the non-3GPP access type 316, the processor 306 is configured to restrict the 3GPP access type 314 in the Tx of the RF transceiver circuit 304. Further, the processor 306 is configured to restrict paging requests once the signal strength of the other access type is greater than the threshold value of signal strength to continue providing required services. In another non-limiting example, if the signal strength of the non-restricted access type reaches below the threshold value of signal strength, then the processor 306 is configured to remove paging restriction to avoid any service discontinuity. Thus, the present scenario avoids modifying existing PDU sessions repeatedly.

FIG. 8B illustrates a line diagram of sequential operations for restricting reception of paging requests based on the temperature of the UE, according to an embodiment of the disclosure.

The sequential operations are shown in FIG. 8B in between the UE 302, the 3GPP access type 314, and the non-3GPP access type 316.

Referring to FIG. 8B, at operations 1 and 2 of FIG. 8B, the UE 302 establishes the MA-PDU session with the 3GPP access type 314 and the non-3GPP access type 316, respectively. Further, at operation 3 of FIG. 8B, the processor 306 is configured to determine that the temperature of the UE 302 is greater than the threshold temperature value. Furthermore, at operation 4 of FIG. 8B, the UE 302 transmits the NAS signaling message to the 3GPP access type 314 via the network interface 312 to restrict paging requests in the MA-PDU session. In operation 5 of FIG. 8B, network interface 312 accepts requests of the NAS signaling message to apply paging restriction on the 3GPP access type 314. In operation 6 of FIG. 8B, the UE 302 moves in idle mode for the 3GPP access type 314 and only uses the non-3GPP access type 316 for data transmission. In another embodiment, in operation 7, if the non-3GPP access type 316 reaches below the threshold value of signal strength, then in operation 8, the UE 302 requests the network interface 312 to remove the paging restriction by transmitting a Registration Request or a Service Request. Further, in operation 9, the network interface 312 accepts the requests from the UE 302 and removes the paging restrictions on the 3GPP access type 314 to avoid any service discontinuity.

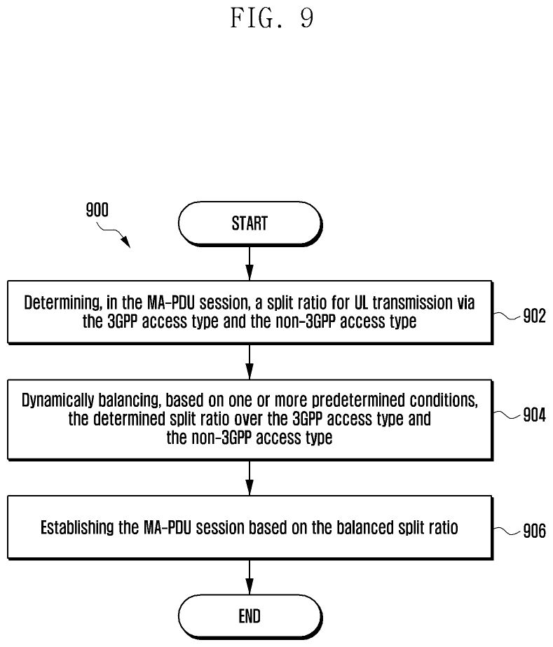

FIG. 9 illustrates a flow chart of a method for establishing the MA-PDU session by determining a split ratio, according to an embodiment of the disclosure.

In the MA-PDU session, the network interface 312 defines a traffic steering information in the ATSSS rule by which the network interface 312 or the UE 302 may send DL and UL data respectively over each access type. In a non-limiting example, the network interface 312 configures the traffic steering information as “Load balancing” and a traffic split ratio as 80% in the non-3GPP access type 316 and 20% in the 3GPP access type 314. However, when network conditions fluctuate frequently over access types e.g. RSRP, SINR, packet error rate, modulation index, and carrier bandwidth changes from cell to cell in 3GPP access, then the method of FIG. 9 defines operations 902 to 906 to change the data split ratio to some delta percentage over one or both access types to enhance user experiences.

Referring to FIG. 9, at operation 902, method 900 includes determining the traffic split ratio for UL transmission via the 3GPP access type 314 and the non-3GPP access type 316. The processor 306 is configured to determine the traffic split ratio from the traffic steering information in the ATSSS rule received from the network interface 312. The flow of the method 900 now proceeds to operation 904.

At operation 904, the method 900 includes dynamically balancing, based on one or more predetermined conditions, the determined traffic split ratio over the 3GPP access type 314 and the non-3GPP access type 316. The one or more predetermined conditions correspond to one of a network bandwidth, a change in quality of service (QOS) rule, an availability of one or more network slices, a packet error rate, a fluctuation in the determined current data rate, a transmission power of UL data, a power consumption rate of the power storage unit of the UE, a change in UE temperature, and a delay in packet delivery. Therefore, the processor 306 is configured to dynamically balance the traffic split ratio based on one or more conditions to avoid any discontinuity of services. In a non-limiting example, initially, the UE 302 is connected over a fourth generation (4G) network connection in the 3GPP access type 314 and a fifth generation core (5GC) network connection over the non-3GPP access type 316 in the MA-PDU session. Thus, the data split ratio (as per the ATSSS rule) is initially defined as 10% of UL data over the 3GPP access type 314 and 90% of UL data over the non-3GPP access type 316. Subsequently, the UE 302 changes a radio access technology (RAT) from the 4G network connection to the 5GC network connection. Therefore, due to higher bandwidth or better QoS rule availability over the 3GPP access type 314, the UE 302 has increased the data split ratio to 20% over the 3GPP access type 314 and 80% over the non-3GPP access type 316 (based on the ATSSS rule provided by the network based on a request from the UE 302). Thus, the load is dynamically balanced based on the one or more predetermined conditions. The flow of the method 900 now proceeds to operation 906.

The traffic split ratio may be dynamically calculated by Equation (1) as mentioned below:

$$Traffic split ratio α F \qquad Equation ( 1 )$$

$$( bandwidth , modulation rate , Subcarrier Spacing , Bit Rate ) /$$

$$F ( packet error rate , Tx power , latency )$$

Thus, the traffic data split ratio over the MA-PDU session is proportional to the bandwidth of the respective access type, modulation rate of each access type, sub-carrier spacing used, and bit rate achieved over each access type. Alternatively, the traffic data split ratio is inversely proportional to the packet error rate of each access type, Tx power, and latency. Further, the traffic split ratio may also depend upon current condition of the UE 302 e.g. remaining energy level, temperature of the UE, etc. In an example embodiment, the traffic data split ratio may also be calculated based on expected network parameters based on historical information relating to corresponding access types in same location and Public Land Mobile Networks (PLMNs). Thus, the UE 302 may deduce a more optimum uplink data split ratio based on the above-discussed parameters.

At operation 906, the method 900 includes establishing the MA-PDU session based on the dynamically balanced split ratio via the 3GPP access type 314 and the non-3GPP access type 316. In continuation with the non-limiting example provided in operation 904, now the UE 302 receives at least one of more packet error rates, fluctuation conditions, higher Tx power, higher battery consumption, higher temperature rise, higher packer delay, or lower bandwidth during communication to the network interface 312 via the 3GPP access type 314. Thus, the UE 302 reduces the UL data split ratio from 20% to 15% via the 3GPP access type 314.

According to an embodiment, network performance may not only depend upon a reference signal received power (RSRP) or signal strength. The network performance may also depend on one or more predefined parameters associated with the access type, such as a signal-to-noise ratio (SNR), a reference signal received quality (RSRQ), a packet error rate, one or more modulation techniques, and so on. Thus, although the 3GPP access type 314 signal strength is well enough but packet error rate increased. Hence, the user may experience some voice or video packet drop and voice and video distortion.

Therefore, the processor 306 is configured to establish, when at least one of the 3GPP access type 314 and the non-3GPP access type 316 is available, an internet protocol (IP) multimedia subsystem (IMS) PDU session as the MA-PDU session during a voice or video call. Further, the processor 306 is configured to dynamically select at least one of the 3GPP access type 314 and the non-3GPP access type 316 for the established MA-PDU session based on each of the one or more predefined parameters associated with the access type.

With the configuration, if any voice or video call is established, the UE 302 may choose any access type (one or both) to send either the voice or video over the IMS PDU session. Once any of the access types have a poor network connection, the UE 302 may select another access type to send most or all of the data via the IMS PDU session. Therefore, the IMS PDU connection ensures no jitter or distortion in ongoing calls.

Referring now to the technical abilities and effectiveness of the method 400 and system 300 as disclosed herein. The following technical advantages over the conventional and existing solutions are provided. The method 400 as disclosed herein above helps in providing one or more solutions to dynamically connect via the normal PDU session and the MA-PDU session to improve user experiences as well as save resources of the UE 302 (less power consumption, less temperature generation). In addition, the method 400 discloses accessing any of the 3GPP access type 314 or the non-3GPP access type 316 even though the UE 302 connected through the MA-PDU session to improve user experiences as well as save resources of the UE 302. Furthermore, the method 400 discloses dynamically uploading data split ratio to maintain the QoS while moving through various network connections.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) for optimizing a multi-access protocol data unit (MA-PDU) session, the method comprising:
determining a corresponding current data rate and a corresponding latency requirement associated with a corresponding application of at least one group of applications running on the UE;
comparing the corresponding current data rate with a predefined threshold data rate or a calculated threshold data rate associated with the corresponding application and comparing the corresponding latency requirement with a predefined threshold latency or a calculated threshold latency associated with the corresponding application;
based on a result of the comparing, determining whether an access type of a network is capable to meet the corresponding current data rate and the corresponding latency requirement; and
establishing one of a normal protocol data unit (PDU) session or an MA-PDU session for the at least one group of applications based on a result of the determining of whether the access type of the network is capable to meet the corresponding current data rate and the corresponding latency requirement.

2. The method of claim 1, further comprising:
establishing the normal PDU session for the at least one group of applications in response to determining that the access type of the network is capable to meet the corresponding current data rate and the corresponding latency requirement.

3. The method of claim 1, further comprising:
establishing the MA-PDU session for the at least one group of applications in response to determining that the access type of the network is incapable to handle the corresponding current data rate and the corresponding latency requirement.

4. The method of claim 1,
wherein the corresponding application of the at least one group of applications corresponds to one or more applications running in a background session or in a foreground session of the UE, and
wherein the at least one group of applications comprises one or more applications having a similar data rate and latency requirement.

5. The method of claim 1,
wherein the predefined threshold data rate corresponds to a fixed data rate value for determining high or low data rate requirements for corresponding applications,
wherein the calculated threshold data rate corresponds to a variable data rate value dynamically calculated based on a heuristic algorithm and a type of corresponding applications for determining high or low data rate requirements for corresponding applications,
wherein the predefined threshold latency corresponds to a fixed latency value for determining high or low latency requirements for corresponding applications, and
wherein the calculated threshold latency corresponds to a variable latency value dynamically calculated based on the heuristic algorithm and the type of corresponding applications for determining high or low latency requirements for corresponding applications.

6. The method of claim 1, wherein the comparing of the corresponding current data rate and the comparing of the corresponding latency requirement comprises:
based on the corresponding current data rate being greater than the predefined threshold latency or the calculated threshold latency, the corresponding application has a high data rate requirement;
based on the corresponding current data rate being less than the predefined threshold latency or the calculated threshold latency, the corresponding application has a low data rate requirement;
based on the corresponding latency being greater than the predefined threshold latency or the calculated threshold latency, the corresponding application has a high latency requirement; and
based on the corresponding latency being less than the predefined threshold latency or the calculated threshold latency, the corresponding application has a low latency requirement.

7. The method of claim 1, wherein the access type corresponds to a third generation partnership project (3GPP) access type and a non-3GPP access type.

8. A user equipment (UE) for optimizing a multi-access protocol data unit (MA-PDU) session, the UE comprising:
a transceiver; and
at least one processor configured to:
determine a corresponding current data rate and a corresponding latency requirement associated with a corresponding application of at least one group of applications running on the UE,
compare the corresponding current data rate with a predefined threshold data rate or a calculated threshold data rate associated with the corresponding application and comparing the corresponding latency requirement with a predefined threshold latency or a calculated threshold latency associated with the corresponding application,
based on a result of the comparing, determine whether an access type of a network is capable to meet the corresponding current data rate and the corresponding latency requirement, and
establish one of a normal protocol data unit (PDU) session or an MA-PDU session for the at least one group of applications based on a result of the determining of whether the access type of the network is capable to meet the corresponding current data rate and the corresponding latency requirement.

9. The UE of claim 8, wherein the at least one processor is further configured to:
establish the normal PDU session for the at least one group of applications in response to determining that the access type of the network is capable to meet the corresponding current data rate and the corresponding latency requirement.

10. The UE of claim 8, wherein the at least one processor is further configured to:
establish the MA-PDU session for the at least one group of applications in response to determining that the access type of the network is incapable to handle the corresponding current data rate and the corresponding latency requirement.

11. The UE of claim 8,
wherein the corresponding application of the at least one group of applications corresponds to one or more applications running in a background session or in a foreground session of the UE, and
wherein the at least one group of applications comprises one or more applications having a similar data rate and latency requirement.

12. The UE of claim 8,
wherein the predefined threshold data rate corresponds to a fixed data rate value for determining high or low data rate requirements for corresponding applications,
wherein the calculated threshold data rate corresponds to a variable data rate value dynamically calculated based on a heuristic algorithm and a type of corresponding applications for determining high or low data rate requirements for corresponding applications,
wherein the predefined threshold latency corresponds to a fixed latency value for determining high or low latency requirements for corresponding applications, and
wherein the calculated threshold latency corresponds to a variable latency value dynamically calculated based on the heuristic algorithm and the type of corresponding applications for determining high or low latency requirements for corresponding applications.

13. The UE of claim 8, wherein the comparing of the corresponding current data rate and the comparing of the corresponding latency requirement comprises:
based on the corresponding current data rate being greater than the predefined threshold latency or the calculated threshold latency, the corresponding application has a high data rate requirement,
based on the corresponding current data rate being less than the predefined threshold latency or the calculated threshold latency, the corresponding application has a low data rate requirement,
based on the corresponding latency being greater than the predefined threshold latency or the calculated threshold latency, the corresponding application has a high latency requirement, and
based on the corresponding latency being less than the predefined threshold latency or the calculated threshold latency, the corresponding application has a low latency requirement.

14. The UE of claim 8, wherein the access type corresponds to a third generation partnership project (3GPP) access type and a non-3GPP access type.

15. The UE of claim 10, wherein the at least one processor is further configured to:
transmit, to the network via the transceiver, an MA-PDU request message to the network, and
establish, based on Access Traffic Steering, Switching, and Splitting access traffic steering, switching, and splitting (ATSSS) rules received by the UE from the network in response to the transmitting of the MA-PDU request message, establishing the MA-PDU session with the network via each of the a third generation partnership project (3GPP) access type and the a non-3GPP access type simultaneously.
